(19) United States
(12) Patent Application Publication
(10) Pub. No.: US 2015/0371172 A1
(43) Pub. Date: Dec. 24, 2015

(54) INTELLIGENT KNOWLEDGE BASED EMPLOYEE IMPROVEMENT AND FORECASTING PROCESS AND SYSTEM

(71) Applicant: REALLINX INC., Richardson, TX (US)

(72) Inventor: Vishal Sean Minter, Richardson, TX (US)

(21) Appl. No.: 14/746,679

(22) Filed: Jun. 22, 2015

Related U.S. Application Data
(60) Provisional application No. 62/015,337, filed on Jun. 20, 2014.

(51) Int. Cl. G06Q 10/06; G06Q 50/20

(52) U.S. Cl. CPC G06Q 10/06398; G06Q 50/2057

(57) ABSTRACT

The present disclosure relates to management of employees that allows for ranking via balanced scorecard, heatmap based on performance to goal, with integrated processes and systems to allow managers to improve performance for any specific category or metric via system generated improvement knowledge base suggestion and tracking of timing and actual metric of improvement. Data and tracking gathered with this method can provide innovative predictable forecasting of future performance based on manager, product or company level statistics.

### RELATED APPLICATIONS

The present application claims priority to and benefit of U.S. Provisional Patent Application No. 62/015,337, filed on Jun. 20, 2014, which is hereby incorporated by reference for all purposes as if set forth herein in its entirety.

### TECHNICAL FIELD

The present disclosure relates generally to a workforce analytics and data mining system as well as artificial intelligence process, and more specifically to a workforce analytics system and method of use that provides managers with feedback regarding employee performance and available techniques to improve employee performance. The system enables managers to review employee performance, training, coaching, and performance improvement plans. It is used by all levels of management hierarchy and title, including entry level management, executive management, human resources, training personnel, operational personnel and quality assurance personnel. The system mines all data input such as coaching, demographics, workforce mood, training, personality, performance metrics and trends to provide top performer employee profiles by job, manager/employee coaching effectiveness by demographic and personality and employee attrition, training effectiveness by demographic and personality. A virtual intelligent assistant is provided to all employees that utilizes the data mining tools above to provide each employee and manager specific tasks and activities to improve employee and company goals.

### BACKGROUND OF THE INVENTION

Workforce analytics systems are used to evaluate employee performance based on a number of parameters, metrics, coaching and training. However, organizations need additional feedback regarding available techniques to improve employee performance in instances of employee under-achievement.

### SUMMARY OF THE INVENTION

The present disclosure relates to management of employees that allows for ranking via balanced scorecard, heatmap and stack ranking based on performance to goal, with integrated processes and systems to allow managers to improve performance for any specific category or metric via system generated improvement, suggested coaching sessions and knowledge base training suggestion and tracking of timing and actual metric of improvement. Data and tracking gathered with this method can provide innovative predictable forecasting of future performance based on manager, product or company level statistics.

The present disclosure relates to a system which proactively suggests how to improve employees based on historical data and understanding of what knowledge data sets has worked for other employees based on demographics, mood and personality. The present disclosure uses sophisticated algorithms based on this actual data and knowledge base set to forecast future performance. The present disclosure also provides data regarding effectiveness of training material; as it tracks performance of the employee after usage of training materials, processes and activities. One exemplary embodiment of the present disclosure also provides audio recordings of coaching sessions. This is an added feature to help the organization develop its management skill sets and create development plans at the management level.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIGS. 1-24 are diagrams of various user interfaces in accordance with an exemplary embodiment of the present disclosure

FIG. 25 is a diagram of an algorithm 100 for analyzing employee performance in accordance with an exemplary embodiment of the present disclosure;

FIG. 26 is a diagram of an algorithm 200 for assigning employee training articles in accordance with an exemplary embodiment of the present disclosure; and

FIG. 27 is a diagram of an algorithm 300 for improving employee performance in accordance with an exemplary embodiment of the present disclosure.

FIG. 28 is a diagram of an algorithm 400 for the intelligent virtual assistant in accordance with an exemplary embodiment of the present disclosure; and

FIG. 29 is a diagram for an algorithm 500 which provides manager performance in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

The present disclosure provides a process and system of business intelligence for companies on performance of employee, manager, department and of the whole organization. The present disclosure takes the following innovative approach:

Data mining and analytics capabilities that allow users to understand employee, manager, department and organizational performance.

Metrics, dashboards and scorecards can be viewed with real time, daily, weekly, monthly, and/or annual performance data.

Features integrated balanced scorecards, performance heat maps, proactive triggers with SmartCoaching, and intelligent Best Practice Blueprints.

Commitment tracking with proactive notification alerts to drive consistent follow up and accountability. Alerts can be based on metric thresholds, coaching commitments for improvement, training commitments and other suitable functional controls.

The Hyper Performer Replication system can be used by an organization to implement performance based pay. The disclosed system is compatible with traditional desktop PCs, mobile tablets and other suitable platforms

Employees and managers access and use of the disclosed system can be configured to provide different content and functionality, based on hierarchy, employee type and other parameters.

The system also provides for voice recording of employee and manager coaching interactions and subsequent storage within a user-accessible framework, to facilitate employee playback, manager coaching evaluations, improved coaching effectiveness of the manager and other functions.

Management of employee performance is provided through the use of coaching forms, process templates, performance analysis, recording of employee commitments and dates by which commitments will occur and other suitable functions. A coaching analysis system is configured to provide historical view data from coaching sessions, individual performance metrics, annotated reasoning from performance evaluation, comparative performance as a function of each metric and other suitable functionality.

Training commitments are agreed to and assigned to an employee either during a coaching or as part of ongoing development. Employees are assigned a date to complete one or more training items, documents, videos or audio files with optional testing to determine knowledge transfer and understanding. The application tracks performance after training to determine if the training improved performance and provide users data regarding the effectiveness of the training.

Quality assurance measurement can be implemented within the system using quality assurance forms that are customizable for different applications. The customizable forms can include a weighted scale to generate an average score using a suitable algorithm, such as the sum of all YES responses in the form divided by total YES responses possible or other suitable equations. The customizable form can be configured for use by alone or more levels of management, to capture behavioral driven activities, tasks demonstrated by an employee during their work process and flow and other suitable activities.

The system can also apply one or more review algorithms on system data using statistical and iterative analysis to identify areas of improvement for one or more parts of the organization, can assign tasks proactively to improve performance and can perform other suitable functions.

The system can also be configured to provide users required with a personality test when a user is setting up their profiles, and the results of the personality test can be used within the system to track actions and interactions that have an associated personality type. The system enables users to identify their mood via emoji settings throughout their day, and can be configured to use that data to understand relationships of employee mood to performance and interactions.

### Login Screen Control System

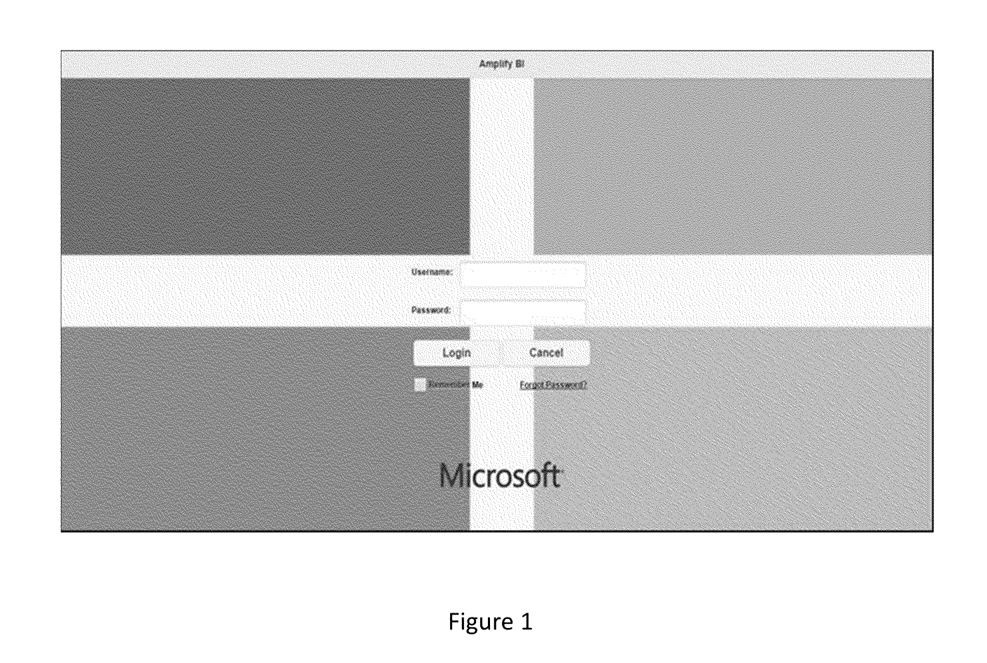

A login screen control system can be provided as a main login screen for users to access the system. In one embodiment of the present disclosure, the login screen control system can have user-selected options including “Remember Me” and “Forgot Password” tools. One embodiment of a login screen control system is depicted in FIG. 1, where system functional components are represented as user interface controls that are generated on a user interface device, such as a touch screen interface, an LED display in conjunction with a mouse or other user interface devices, or other suitable user interface devices. The user interface components disclosed herein can be implemented as one or more objects, each having associated graphical, functional and text attributes, which can be instantiated in response to a user selection or other system functions, or in other suitable manners.

### Performance Dashboard Control System

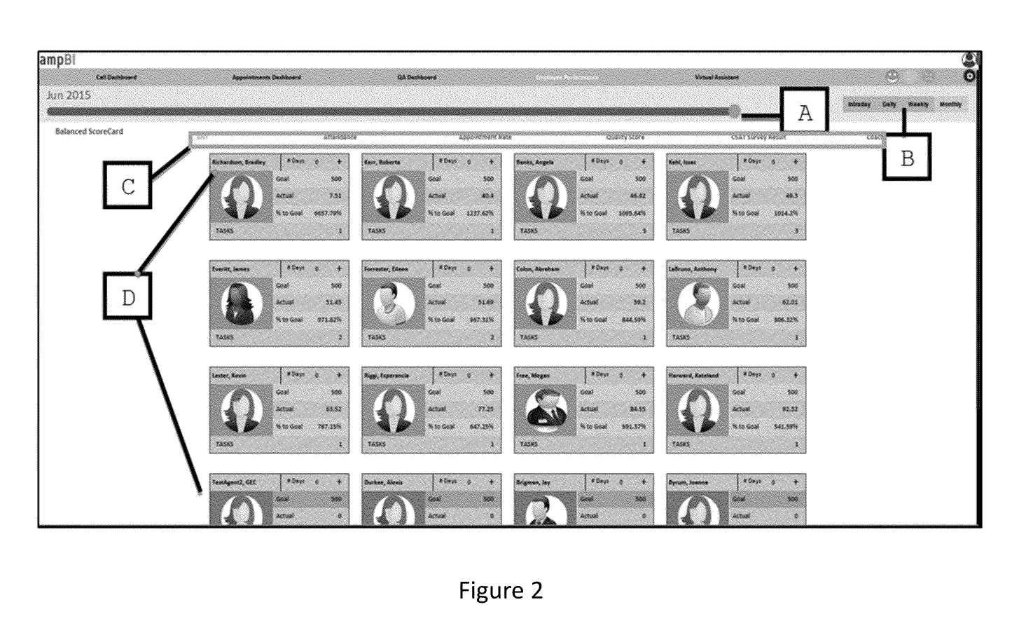

The performance dashboard control system can be configured to display an “All Employee” view that is generated when a user activates the system and successfully passes access controls, and can be the starting point for other functions within the application. One embodiment of the performance control dashboard system is depicted in FIG. 2, where system functional components are represented as user interface controls that are generated on a user interface device. The labeled items depicted in FIG. 2 are summarized below:

| Label | description/function |
|---|---|
| A | Date Slider: allows a user the ability to scroll to |
| | change calendar dates |
| B | Timeframe selection options: Intraday, daily, weekly, |
| | monthly options |
| C | KPI/metric selections for employee metric tile view |
| D | Employee tile view with heat map style color indicator |

### Scorecard View Control System

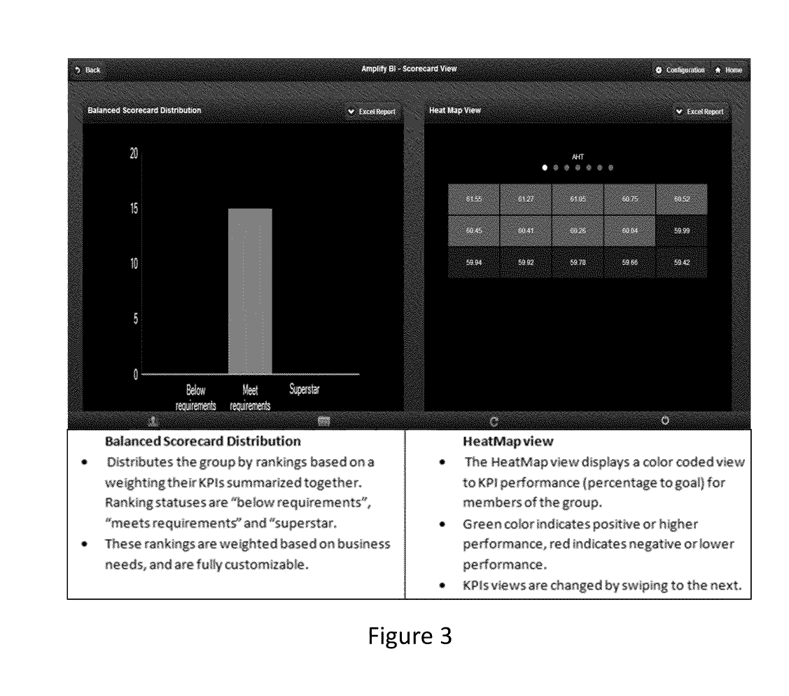

A scorecard view controller system is configured to generate a balanced scorecard distribution graphic as shown in FIG. 3, such as by generating a database query for a number of KPIs associated with a selected employee and associated range data for KPIs that are below an acceptable requirement rating, equal to an acceptable requirement rating and greater than an acceptable requirement rating, and then by generating a graphic that shows a number of KPIs for the employee that are below the requirement rating, a number of KPIs for the employee that are equal to the requirement rating, and a number of KPIs for the employee that are greater than the requirement rating, such as in a bar chart or other suitable graphic display. In addition, an adjacent graphic display can show an itemized display of the score received for each KPI and can include a color code for each KPI that indicates whether the score is below a requirement rating, equal to a requirement rating or greater than a requirement rating, such as by using a look up table that stores a color associated with each rating range and by assigning the associated color to each graphic icon in a display of graphic icons.

### Left Panel Scorecard Filter Control System

In one embodiment of the present disclosure, a scorecard view control system can be configured to generate a graphic for each user within the group, and can allow users to customize and configure the scorecard filter controls to view the team performance for select users and groups, such as by tenure and call type selected by the user through the left panel button of the scorecard view or in other suitable manners.

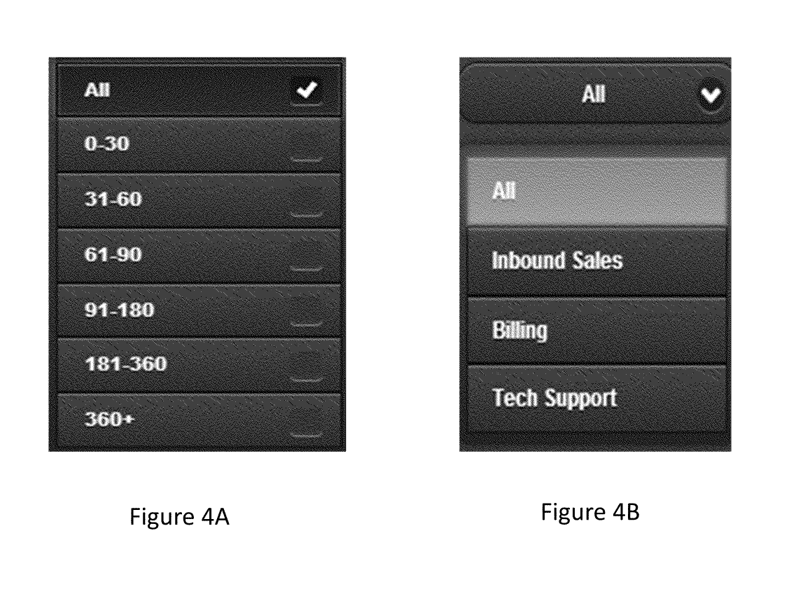

In one embodiment of the present disclosure, the tenure filter control option system is in days with the options depicted in FIG. 4a, where system functional components are represented as user interface controls that are generated on a user interface device.

In one embodiment of the present disclosure, the Call Type Filter Control option can be based on various KPI metrics with the options depicted in FIG. 4b, where system functional components are represented as user interface controls that are generated on a user interface device.

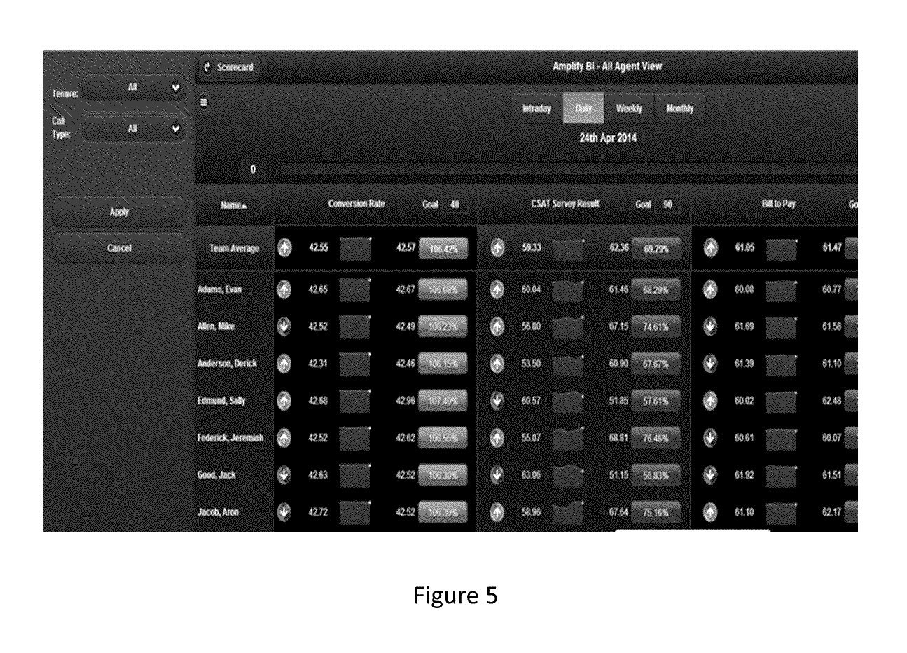

Once filter are set, users implement the Scorecard Filter Control by pressing “Apply.” Alternatively, users can press “Cancel” to abandon the filter and close the left panel of the Scorecard Filter Control display. Once the user as selected “Apply,” the Scorecard Filter Control will display employees based on the applied filters as depicted in FIG. 5, where system functional components are represented as user interface controls that are generated on a user interface device.

### Trigger Control

In one embodiment of the present disclosure, the system has a “trigger” functionality to automatically notify the manager when his/her employees reach KPI goals (or fail to reach KPI goals) with user-customizable options.

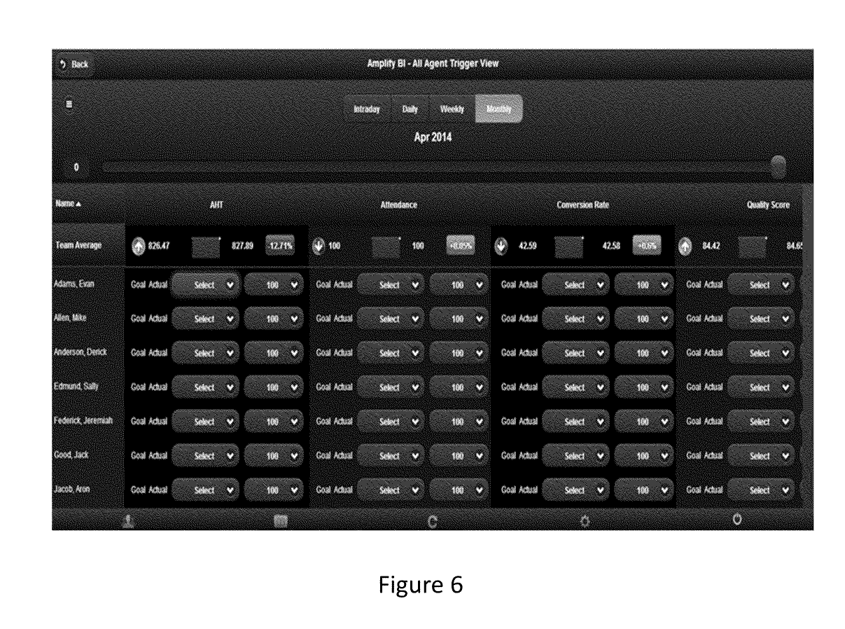

The Trigger page displays each employee and their KPI performance results from the Scorecard View Control. The user is able to quickly select triggers for specific KPIs to notify if and/or when an employee or group falls greater than, less than or equal to a specific KPI target. One embodiment of this Trigger Control is depicted in FIG. 6, where system functional components are represented as user interface controls that are generated on a user interface device.

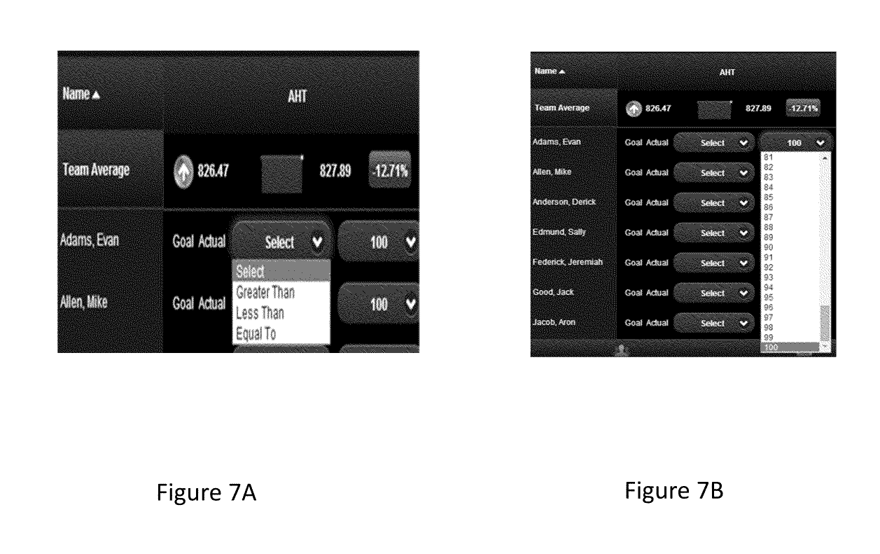

Within the Trigger Control display, users select various Trigger Options for employees using drop down selection tools within each KPI column. An exemplary embodiment of the present disclosure Trigger Option display is depicted in FIGS. 7a and 7b, where system functional components are represented as user interface controls that are generated on a user interface device.

### Team Manager Task List

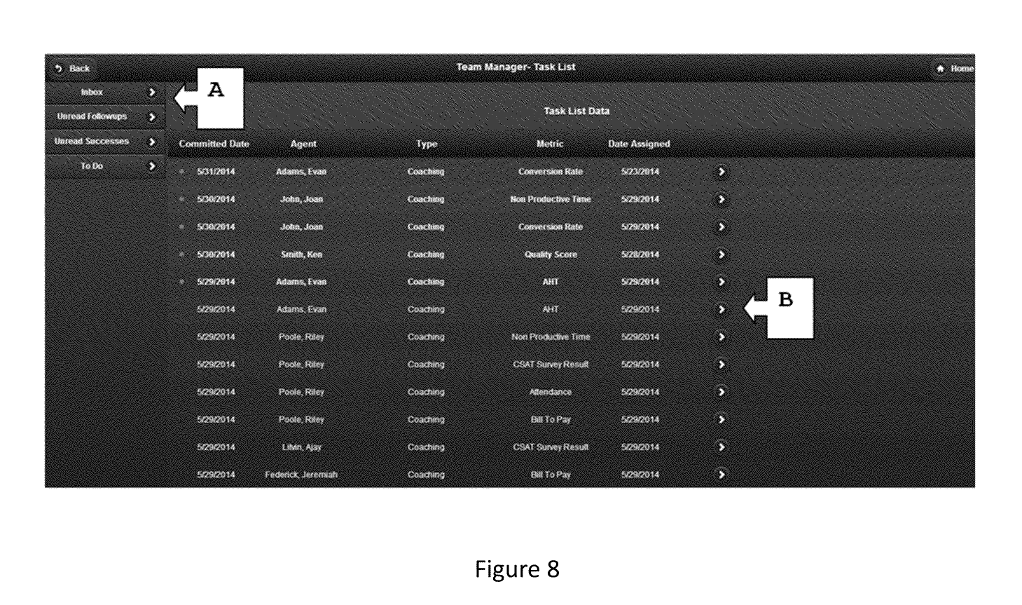

The Team Manager Task List can be configured to allow managers to easily review system generated notifications pertaining to coaching and training commitments. This enables the manager to determine tasks for the day to add to their to do list, coachings to conduct, coachings to schedule, training to review immediately and training to reassign. One embodiment of this Team Manager Task List is depicted in FIG. 8, where system functional components are represented as user interface controls that are generated on a user interface device. The labeled items depicted in FIG. 8 as “Arrow A” are summarized below:

Inbox: All commitments met and not met, sorted by most recent commitment date first. The system generates a message to the inbox as a notification

Unread follow ups: Unread commitments not met

Unread successes: Unread commitments met

To do: A list of all unmet commitments requiring follow up, tagged as “to do” by the manager

FIG. 8 is an exemplary embodiment of a screen of the main Team Manager Task List landing page, where system functional components are represented as user interface controls that are generated on a user interface device.

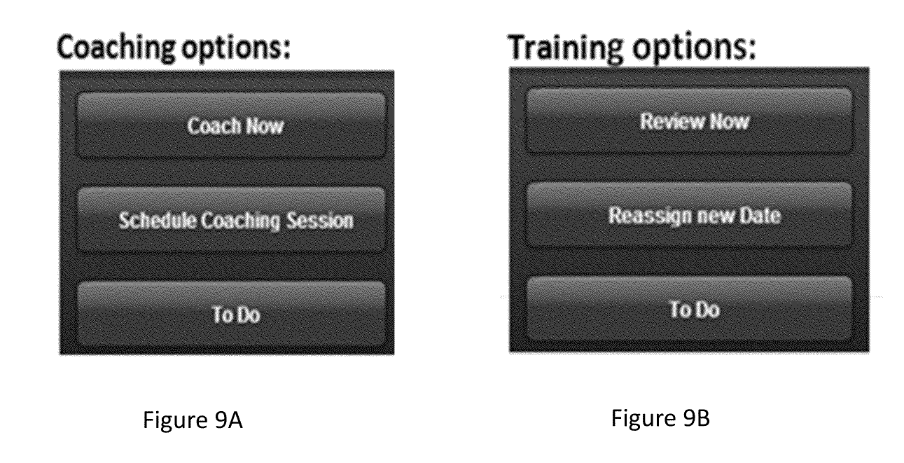

The system can be configured to generate a pop up window of options when particular user interface elements are selected. These options are identified as “Arrow B” of FIG. 8. The options provided are unique for coaching and training notifications and are depicted in FIGS. 9a and 9b, where system functional components are represented as user interface controls that are generated on a user interface device.
“Coach now” takes the manager to a new coaching form
“Schedule a coaching session” allows the manager to schedule a session
“To do” adds the item into the “to do” list
“Review Now” opens the training item to review with the employee immediately
“Reassign new date” enables the manager to reassign the training with a new due date

From the Team Manager Task List screen, a manager can open coaching related notifications found in the inbox, both unread folders and to do list by selecting the notification item on the available user interface. Opening the notification takes the manager to the coaching history screen.

This screen provides the following information:
Employee name
Date coached
Metrics selected
Reason codes selected
Goals
Actual
Commitments
Commitment due date
Strengths and opportunities
Playback of audio recording from coaching session
Blueprint Knowledge Base articles assigned
Coaching history tab details

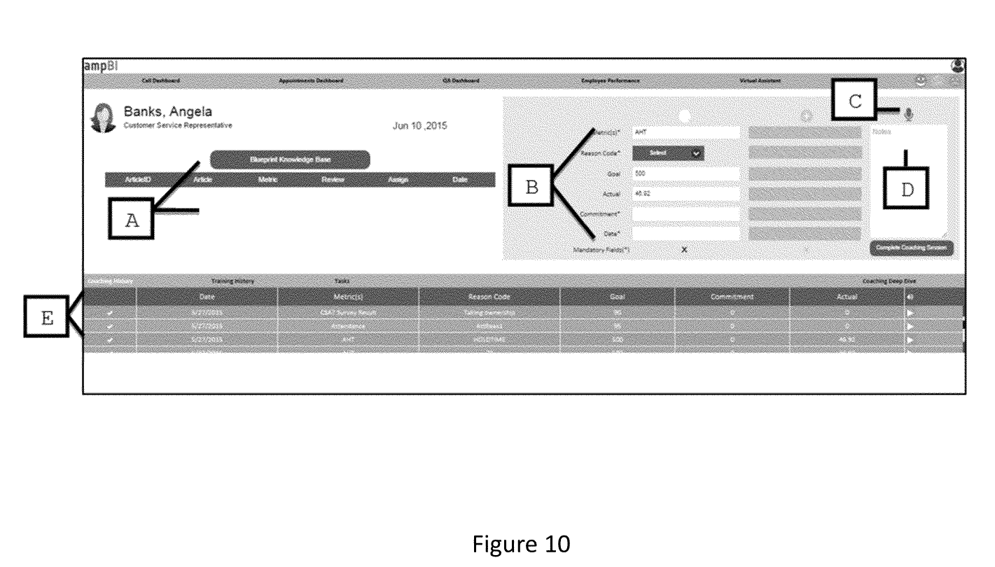

FIG. 10 is an exemplary embodiment of the coaching screen generated when clicking on a coaching notification, where system functional components are represented as user interface controls that are generated on a user interface device. The labeled items depicted in FIG. 10 are summarized below:

| Label | description/function |
|---|---|
| A | Blueprint Knowledgebase access and recommended articles |
| B | Coaching detail capture: metric, reason, goal, actual, |
| | commitment, date |
| C | Record: record coaching session for playback |
| D | Notes capture field |
| E | Historical details of coaching, training and tasks |

### Virtual Assistant

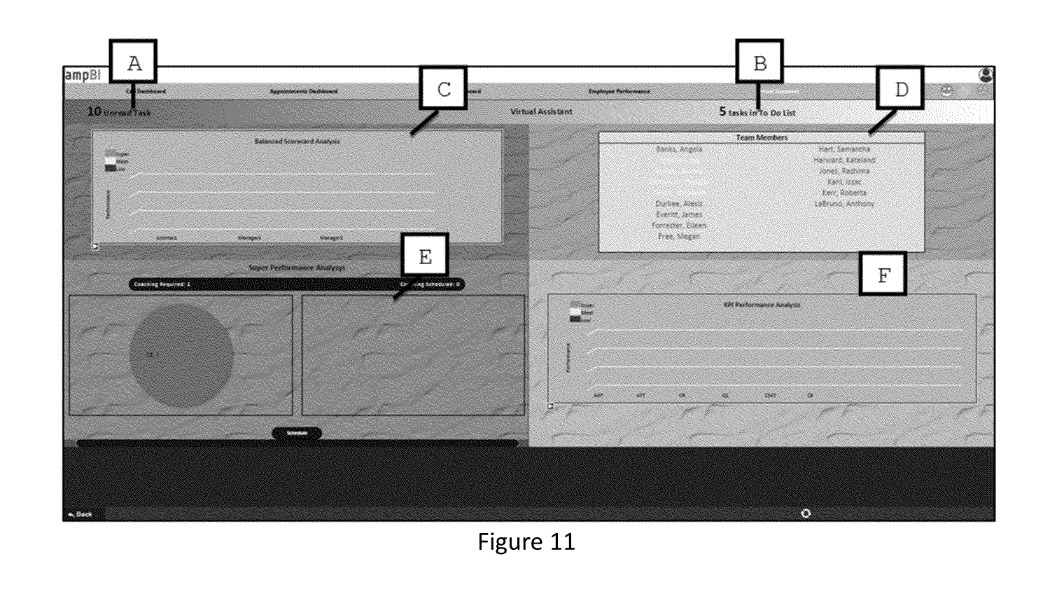

FIG. 11 is an exemplary embodiment of the virtual assistant screen, where system functional components are represented as user interface controls that are generated on a user interface device. The virtual assistant screen provides a manager a complete view of his/her performance and the performance of his/her team. The labeled items depicted in FIG. 11 are summarized below:

| Label | description/function |
|---|---|
| A | Unread task notification, with count |
| B | Tasks To Do notification, with count |
| C | Balanced Scorecard Analysis |
| D | Team Member roster with color scale (heat map) indicator |
| | of overall performance status |
| E | Super performance analysis |
| F | KPI performance analysis |

### Single Employee View

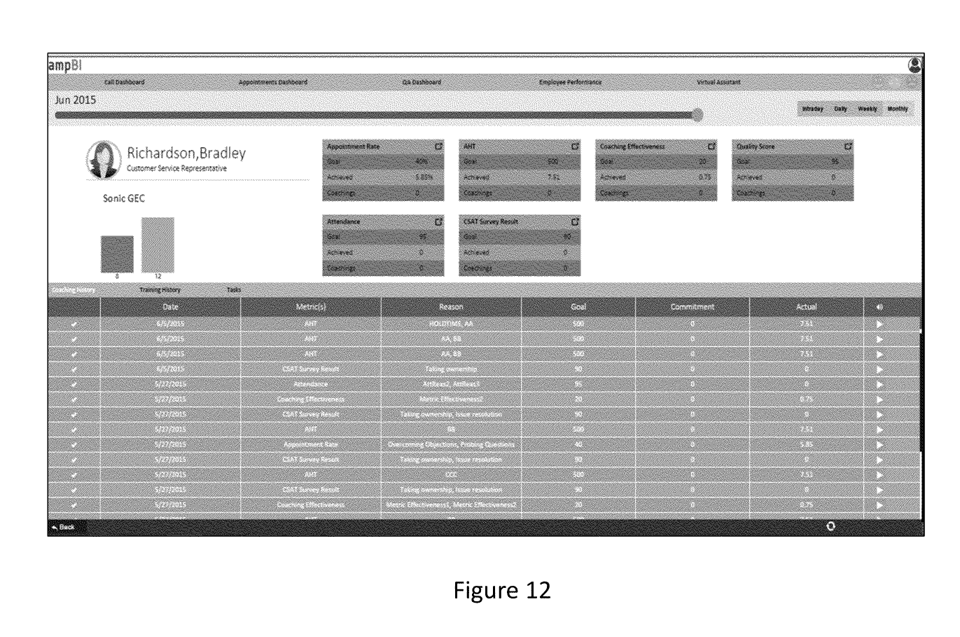

In one embodiment of the present disclosure, users select the Single Employee View Control from the Scorecard View Control display. The Single Employee View Control provides details on KPI performance from the Scorecard View, Coaching History, Commitment Results (both complete and pending), and any other suitable alternatives. The Single Employee View Control provides users with Functional Option Control to “Coach Now” for specific KPI metrics, schedule coaching sessions, evaluate using quality forms, and assign training to employees. An exemplary embodiment of the Single Employee View Control is depicted in FIG. 12, where system functional components are represented as user interface controls that are generated on a user interface device.

### Coaching History

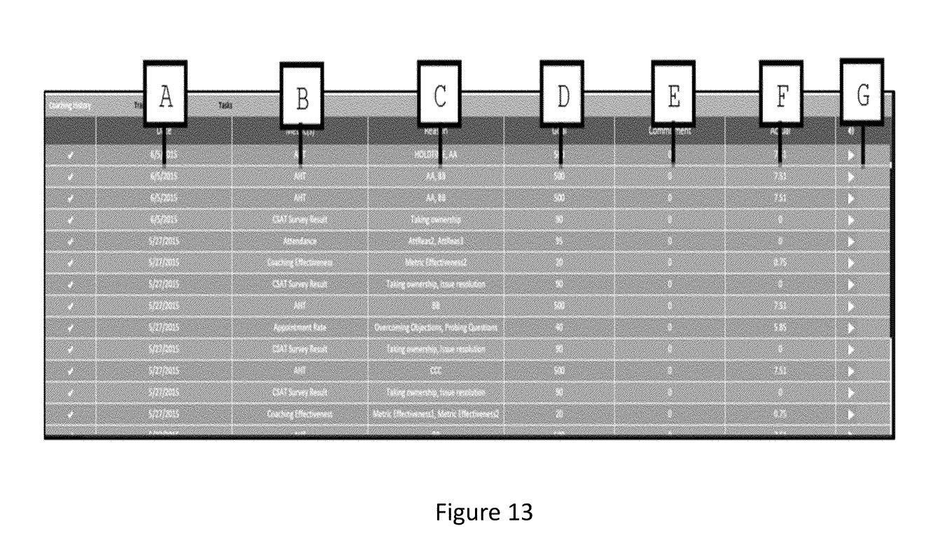

FIG. 13 is an exemplary embodiment of a screen configured to depict coaching history information, where system functional components are represented as user interface controls that are generated on a user interface device. The labeled items depicted in FIG. 13 are summarized below:

| Label | description/function |
|---|---|
| A | Date of coaching |
| B | Metric(s) |
| C | Reason code |
| D | Goal (metric) |
| E | Commitment for metric performance |
| F | Actual metric performance |
| G | Recorded coaching session audio playback: play button |

### Training History

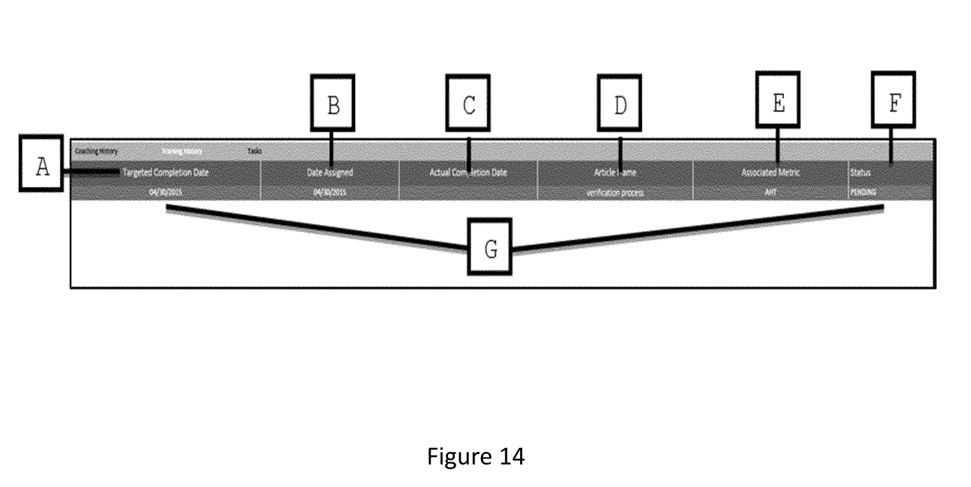

FIG. 14 is an exemplary embodiment of a screen configured to depict training history information, where system functional components are represented as user interface controls that are generated on a user interface device. The labeled items depicted in FIG. 14 are summarized below.

| Label | description/function |
|---|---|
| A | Target completion date |
| B | Date assigned |
| C | Actual completion date |
| D | Article name |
| E | Associated metric |
| F | Status |
| G | Record of training list |

Tasks (Assigned to Employee)

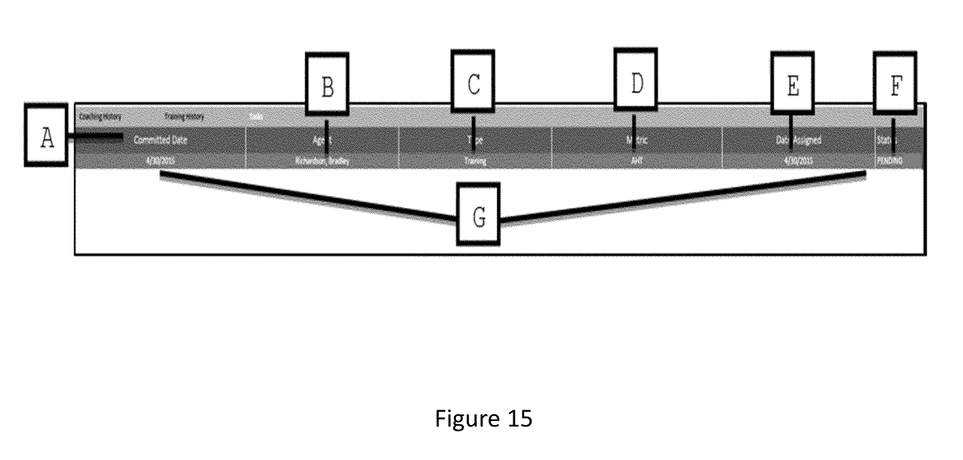

FIG. 15 is an exemplary embodiment of a screen configured to tasks assigned to particular employees, where system functional components are represented as user interface controls that are generated on a user interface device. The labeled items depicted in FIG. 15 are summarized below.

| Label | description/function |
|---|---|
| A | Commitment date |
| B | Agent (name) |
| C | Type (type of task) |
| D | Metric |
| E | Date assigned |
| F | Status |
| G | Record of tasks list |

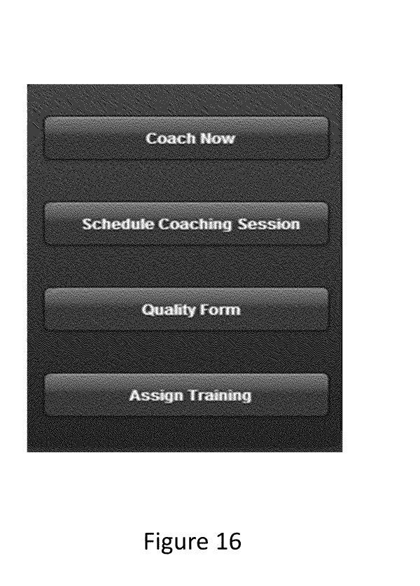

In one embodiment of the Single Employee View Control, users select the Functional Option Control discussed above and referenced as element “C” of the table above. An exemplary embodiment of the Functional Options Control of the Single Employee View Control is depicted in FIG. 16, where system functional components are represented as user interface controls that are generated on a user interface device.

In one embodiment of the present disclosure, users may select “Schedule Coaching Session” from the Functional Options Control. This provides the user with the ability to schedule coaching sessions with the Employee View Control display. A notice can be sent to the employee of the upcoming coaching session.

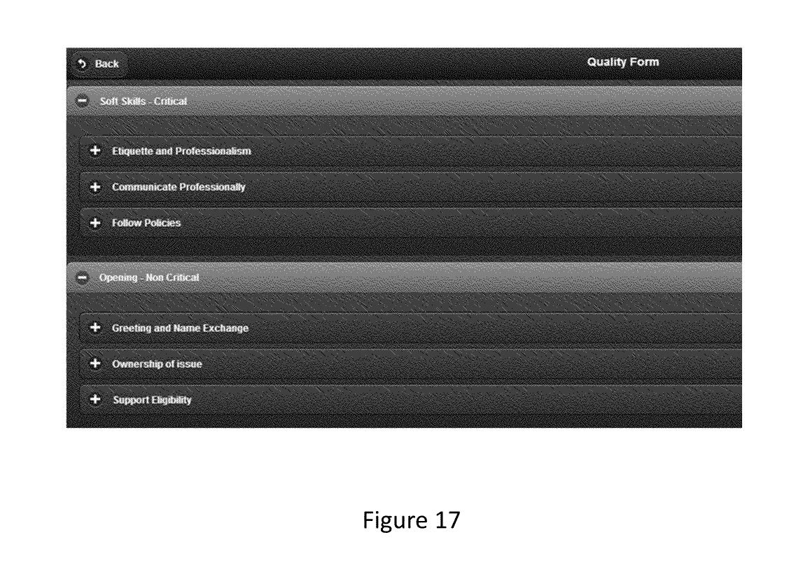

In one exemplary embodiment of the present disclosure, users may select “Quality Form” from the Functional Options Control. This provides the user with the ability to conduct a quality monitoring using a designated quality form. The designed quality form can be housed within the tool, and the system can be configured to link to a form housed within various quality monitoring programs. The designed quality form is used during call monitoring to gauge employee behaviors based on quality guidelines. The designed quality form can be customizable based on individual user or employer business needs. Finally, sections of the forms may be expanded or collapsed for easy viewing and use by users. An exemplary embodiment of the “Quality Form” display is depicted in FIG. 17, where system functional components are represented as user interface controls that are generated on a user interface device.

In one embodiment of the present disclosure, users may select “Coach Now” from the Functional Options Control. User selection of “Coach Now” generates a coaching form display which allows for entry and storage of the following data:
Metric being coached
Audio recording of coaching session
Reason code
Goal and Actual KPI performance
Commitment and date
Strengths and opportunities
Blueprint Knowledge Base
Display of coaching history
Deep Dive

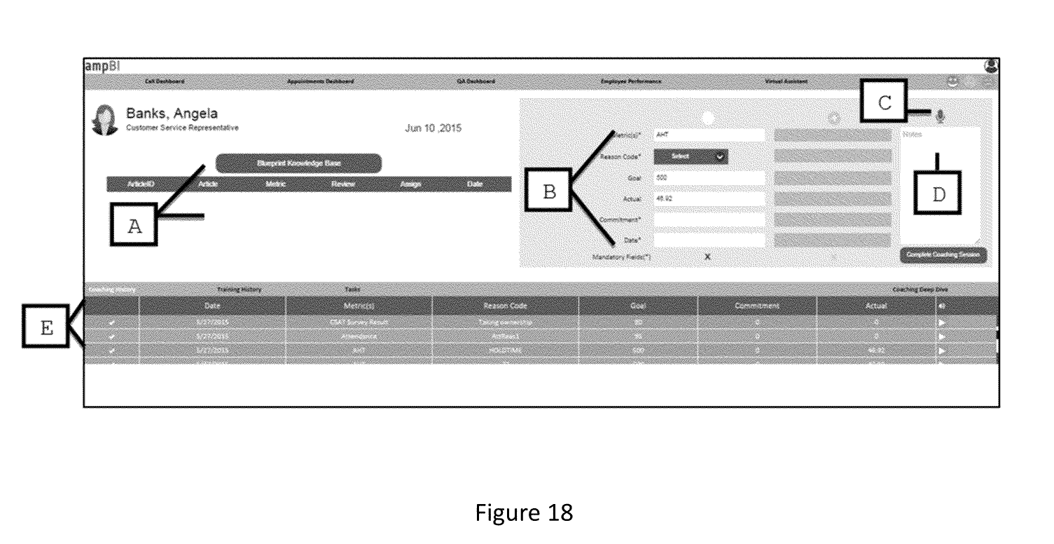

An exemplary embodiment of the “Coach Now” display interface is depicted in FIG. 18, where system functional components are represented as user interface controls that are generated on a user interface device. The labeled items depicted in FIG. 18 are summarized below:

| Label | description/function |
|---|---|
| A | Blueprint Knowledgebase access and recommended articles |
| B | Coaching detail capture: metric, reason, goal, actual, |
| | commitment, date |
| C | Record: record coaching session for playback |
| D | Notes capture field |
| E | Historical details of coaching, training and tasks |

### Deep Dive Control

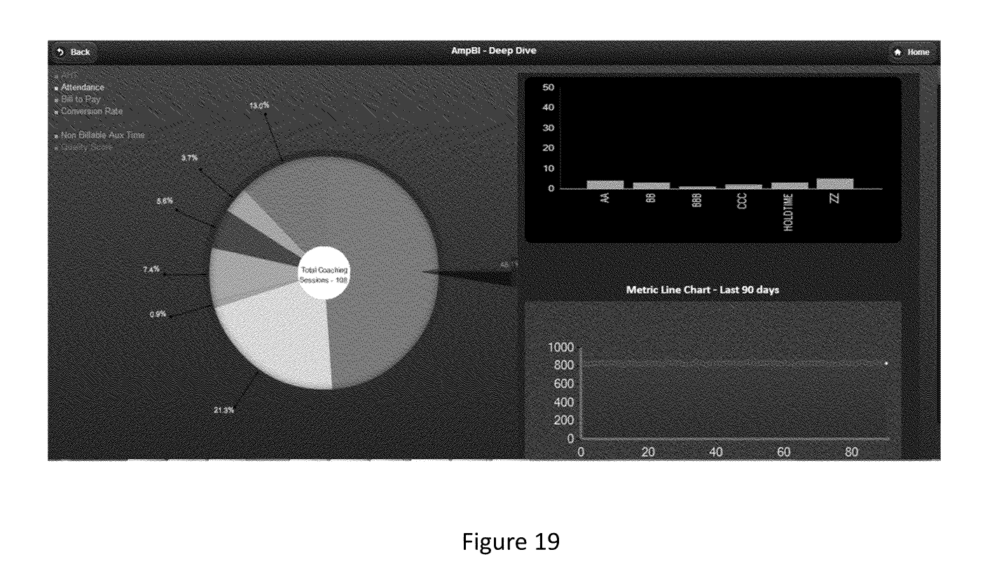

During coaching sessions, the system can be configured to allow users to perform a detailed analysis, or “Deep Dive,” of employee performance. The Deep Dive Control can be configured to display all coaching sessions within the last 90 days, and the percentage of reasons within those coaching sessions. An exemplary embodiment of the “Deep Dive” control display is depicted in FIG. 19, where system functional components are represented as user interface controls that are generated on a user interface device.

In one embodiment of the present disclosure, the control display can be operated and manipulated by users to rotate the informational graphics (including the pie chart displayed above) to display details on the coaching reasons in an additional side panel (depicted in the chart on the right-side above). This is used to show employees and users the overall coaching distribution of topics, improvements, trends in performance, and any other suitable information.

### Blueprint Knowledge Base Control

In one embodiment of the present disclosure, as part of the coaching process, the system can be configured to provide employees with verbal feedback and coaching from the manager. With the use of this system described in the present disclosure, users and employees also access an analytical training tool referred to herein as the “Blueprint Knowledge Base Control” to aide in employee development.

The Blueprint Knowledge Base Control stores articles specific to KPIs and KPI sub metrics, used to refresh, train, retrain or enhance skills applicable while conducting coaching. When a particular article is used to train an individual employee, the performance of the article in relation to the employee's resulting performance is stored to provide feedback on the efficiency of each training article. The articles are recommended for use in training employees in order from top to bottom based on historical performance results after usage. As commitments are met/not met, the article usage order is affected based on the success/failure in helping the employee to meet performance commitments.

In one embodiment of the present disclosure, articles are able to be rated by a user based on personal preference. These user ratings are used to influence the recommendation ranking of the article for a particular employee.

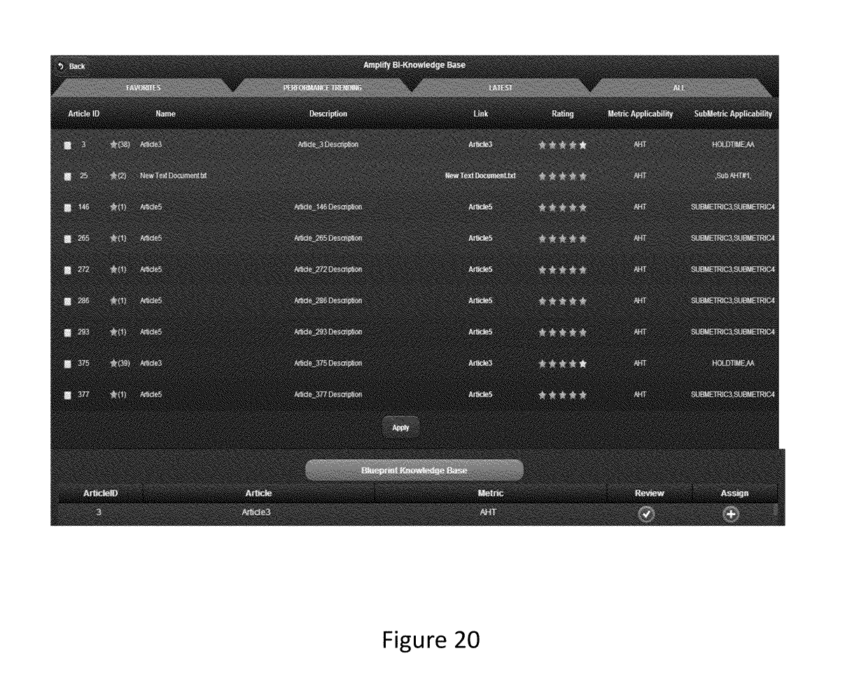

In one embodiment of the present disclosure, the Blueprint Knowledge Base Control display has four tabs: favorites, performance trending (recommended based on historical results), latest (new), and all. The user selects one of these four tabs to view articles, select an article they wish to use for an employee, and “Apply” the article to the employee. The options for article utilization include review with the employee real time, or assign it to employees for later viewing. An exemplary embodiment of the present disclosure Blueprint Knowledge Base Control display is depicted in FIG. 20, where system functional components are represented as user interface controls that are generated on a user interface device.

### Complete Coaching

After the user has conducted a review of the Deep Dive Control display, set performance goals for the employee, secured an employee commitment regarding their performance, and assigned specific article to train employees, the coaching can be completed by selecting the “complete coaching button” on the “Coach Now” display interface. Once the coaching session is completed, the interaction is stored into the “Coaching History” for the single employee as well as Blueprint Knowledge Base Control database for the specific article assigned.

### Coaching History Tab

In one embodiment of the present disclosure, the system can be configured to include a database for Coaching History for keeping records on the following data:
Date
Audio file recorded from the coaching session Metric(s)
Reason codes associated with a metric
Goal (of KPI)
Commitment (KPI result expected)
Actual (actual KPI result at commitment date end)
Commitment date set
Status (complete, not complete)
Color labeled commitments
   Grey: future commitment
   Red: past commitment not met
   Green: past commitment met

Once a commitment date arrives, the system can be configured to determine whether a particular coaching session has been completed based on a number of parameters. Based on this determination, the system can be configured to assign a particular color coding status indicator to each assignment. Color coding of green or red is a visual indicator of whether the commitment was successfully met, in conjunction with reviewing the actual column against the commitment set. If not met, the system codes the item red and sends a notification to the Follow Up notifications for the manager to review. An exemplary embodiment of the Coaching History display in accordance with the present disclosure is depicted in FIG. 13, where system functional components are represented as user interface controls that are generated on a user interface device. The labeled items depicted in FIG. 13 are once again summarized below:

| Label | description/function |
|---|---|
| A | Date of coaching |
| B | Metric(s) |
| C | Reason code |
| D | Goal (metric) |
| E | Commitment for metric performance |
| F | Actual metric performance |
| G | Recorded coaching session audio playback: play button |

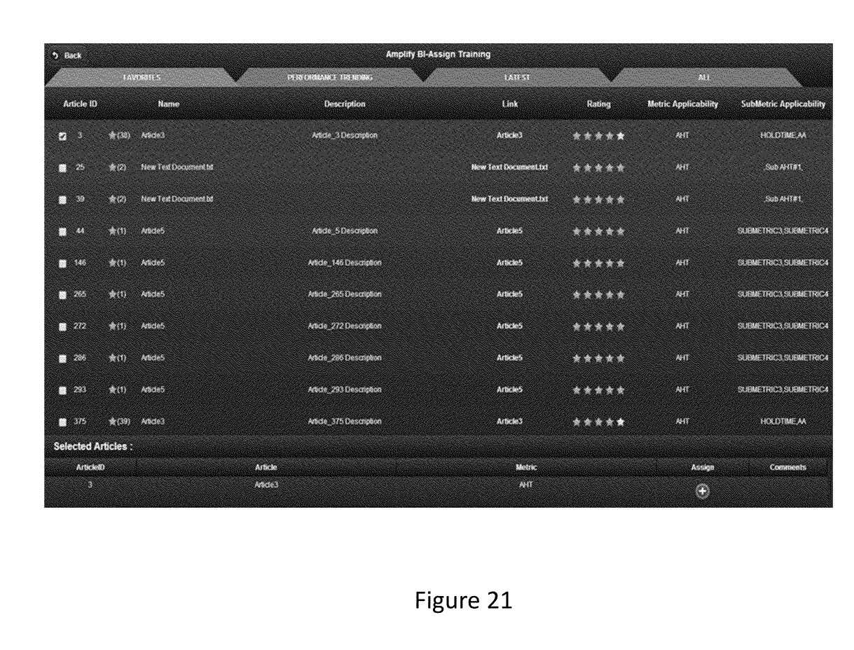

In one embodiment of the present disclosure, users may select “Assign Training” from the Functional Options Control. User selection of “Assign Training” allows the user to access the Blueprint Knowledge Base Control (described above) to select the appropriate training articles for assignment to the employee. An exemplary embodiment of the “Assign Training” display interface of the present disclosure is depicted in FIG. 21, where system functional components are represented as user interface controls that are generated on a user interface device.

### Training History Tab

The Blueprint Knowledge Base Control system can be configured to assign training during a coaching session or as ongoing training development. Once assigned, the training history control tracks the status of completion.

The training history control keeps record of all training details:
Targeted completion date
Date assigned
Actual completion date
Article name
Associated metric
Status
Color labeled commitment
Color labeled commitments
   Grey: future commitment
   Red: past commitment not met
   Green: past commitment met

Once a commitment date arrives, the system deems the status complete. If met, the system codes the item green. If not met, the system codes the item red and sends a notification to the “Follow Up” notifications for the manager to review.

FIG. 14 is an exemplary embodiment of a screen depicting a sample training history, where system functional components are represented as user interface controls that are generated on a user interface device. The labeled items depicted in FIG. 14 are summarized below:

| Label | description/function |
|---|---|
| A | Target completion date |
| B | Date assigned |
| C | Actual completion date |
| D | Article name |
| E | Associated metric |
| F | Status |
| G | Record of training list |

### Organization Dashboard

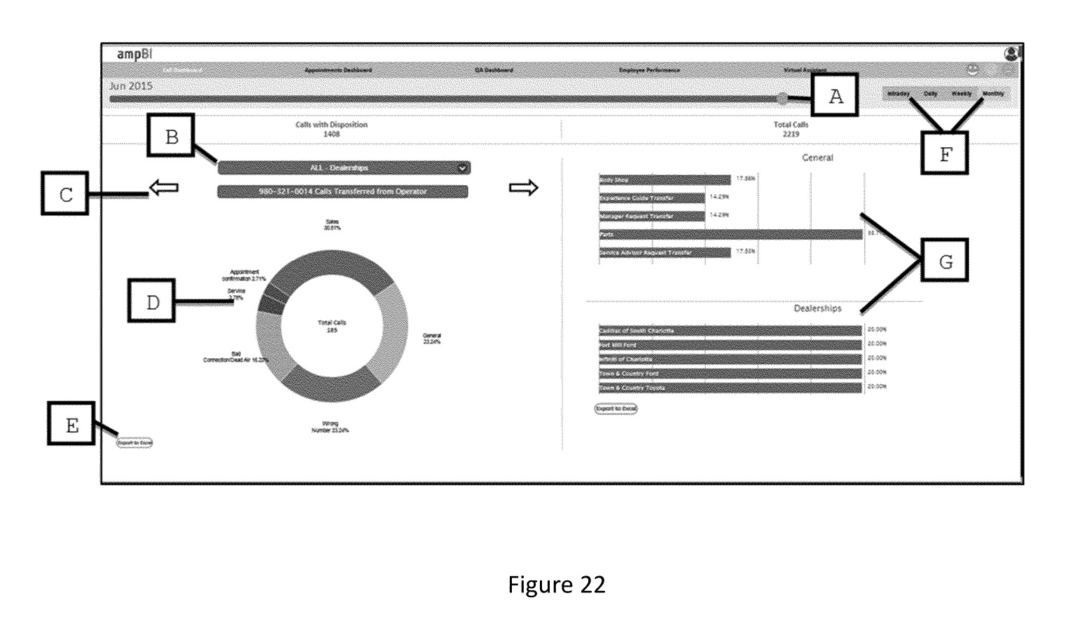

FIG. 22 is an exemplary embodiment of an organization dashboard as disclosed in the present disclosure, where system functional components are represented as user interface controls that are generated on a user interface device. The organization dashboard is configured to provide a summary of company performance to executive management which is an aggregate of performance of all employees and managers. This dashboard allows executive management to review employee and manager performance and forecast future performance based on the virtual assistant AI tool provided. The labeled items depicted in FIG. 22 are summarized below:

| Label | description/function |
|---|---|
| A | Date Slider: allows a user the ability to scroll to |
| | change calendar dates |
| B | Business departments/topics/call types/dispositions drop |
| | down allowing drill down |
| C | Arrows allow changes to subtopics of business |
| | departments/topics/call types/dispositions |
| D | Pie chart graphical view of business |
| | departments/topics/call types/dispositions distribution |
| E | Export: Allows users to export data to Microsoft Excel |
| F | Timeframe selection options: Intraday, daily, weekly, |
| | monthly options |
| G | Right panel displays details of subtopics, when selected |

### Agent Home Page “My Metrics”

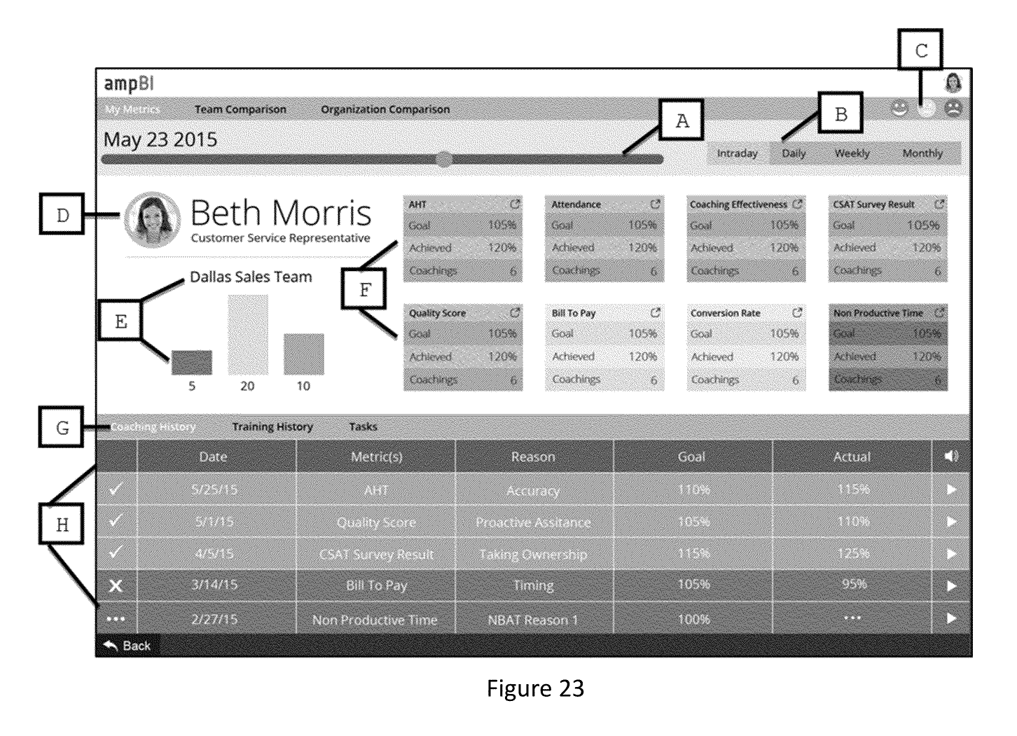

FIG. 23 is an exemplary embodiment of an employee's “My Metrics” personal information page in accordance with the present disclosure, where system functional components are represented as user interface controls that are generated on a user interface device. The employee portal allows each employee to login to the system and view a customized dashboard showing their performance as well as assigned tasks as well as coaching and training activities. The labeled items depicted in FIG. 23 are summarized below:

| Label | description/function |
|---|---|
| A | Date Slider: allows a user the ability to scroll to |
| | change calendar dates |
| B | Timeframe selection options: Intraday, daily, weekly, |
| | monthly options |
| C | User mood emoticon selection |
| D | User profile image with color coded performance |
| | indicator |
| E | Graphical comparison of team performance |
| F | Metric performance details |
| G | Coaching History, Training History and Tasks tabs |
| H | History list of coaching and training |

### Agent View: Team Comparison

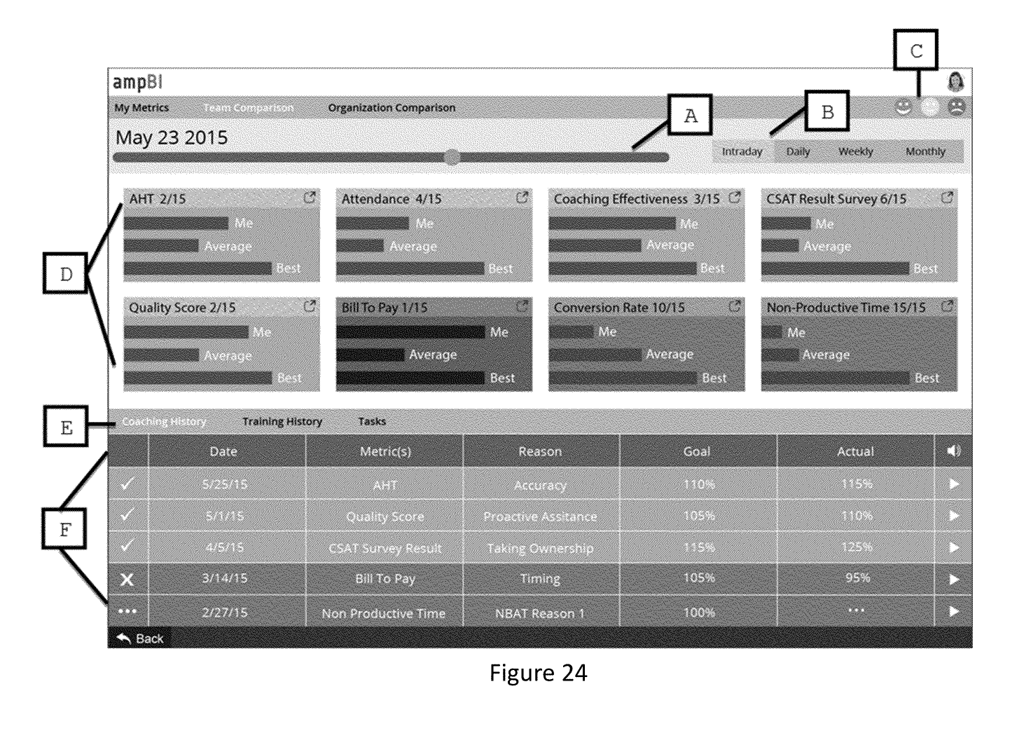

FIG. 24 is an exemplary embodiment of an employee's “Team Comparison” information page in accordance with the present disclosure, where system functional components are represented as user interface controls that are generated on a user interface device. Within the employee portal, the employee can view comparisons of performance to their team or the organization. The labeled items depicted in FIG. 24 are summarized below:

| Label | description/function |
|---|---|
| A | Date Slider: allows a user the ability to scroll to |
| | change calendar dates |
| B | Timeframe selection options: Intraday, daily, weekly, |
| | monthly options |
| C | User mood emoticon selection |
| D | Agent metric performance tiles with graphical comparison |
| | to team or organization |
| E | Coaching History, Training History and Tasks tabs |
| F | History list of coaching and training |

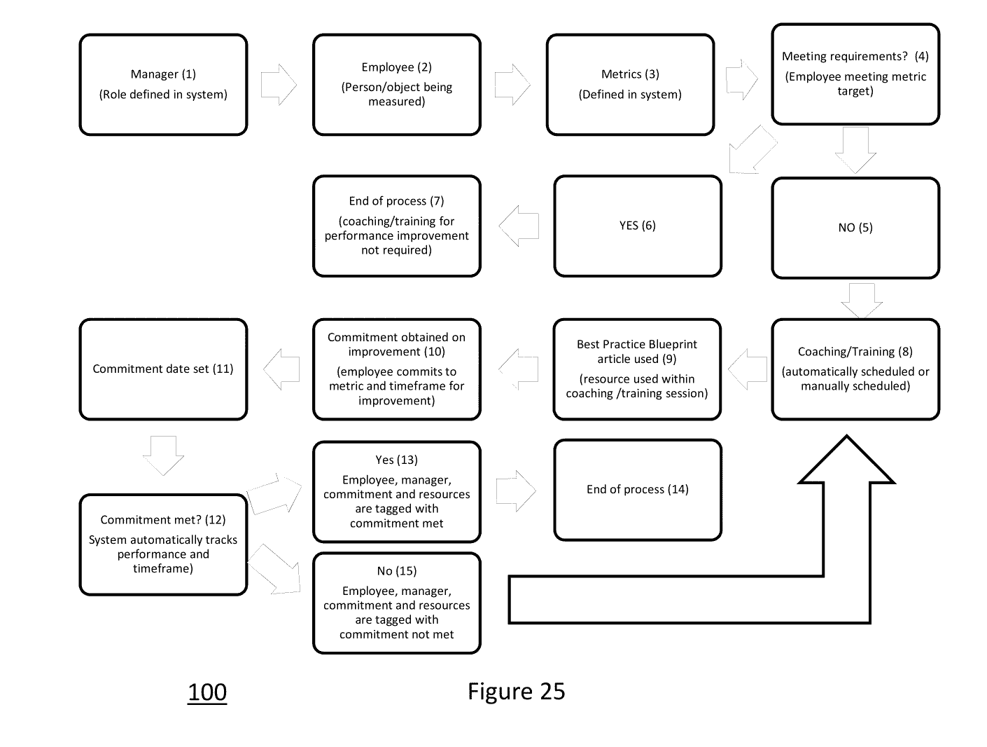

FIG. 25 is a diagram of an algorithm for analyzing employee performance in accordance with an exemplary embodiment of the present disclosure. Algorithm 100 is implemented in hardware or a suitable combination of hardware and software, and can be one or more software systems operating on one or more processors.

As used herein, “hardware” includes a combination of discrete components, an integrated circuit, an application-specific integrated circuit, a field programmable gate array, or other suitable hardware. As used herein, “software” includes one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

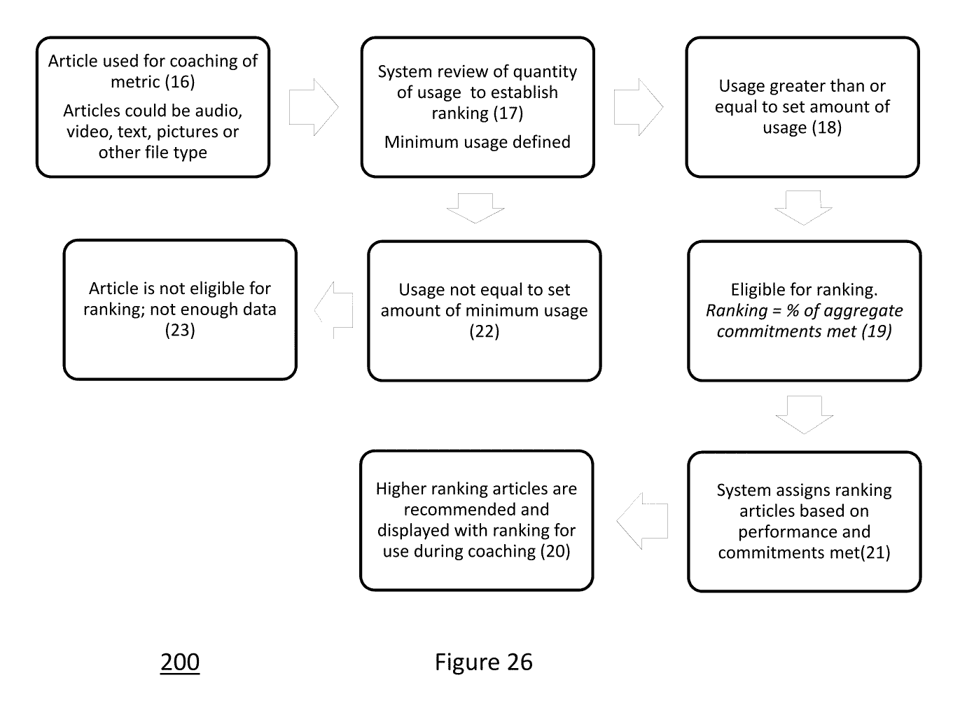

FIG. 26 is a diagram of an algorithm for assigning employee training articles in accordance with an exemplary embodiment of the present disclosure. Algorithm 200 can be implemented in hardware or a suitable combination of hardware and software, and can be one or more software systems operating on one or more processors.

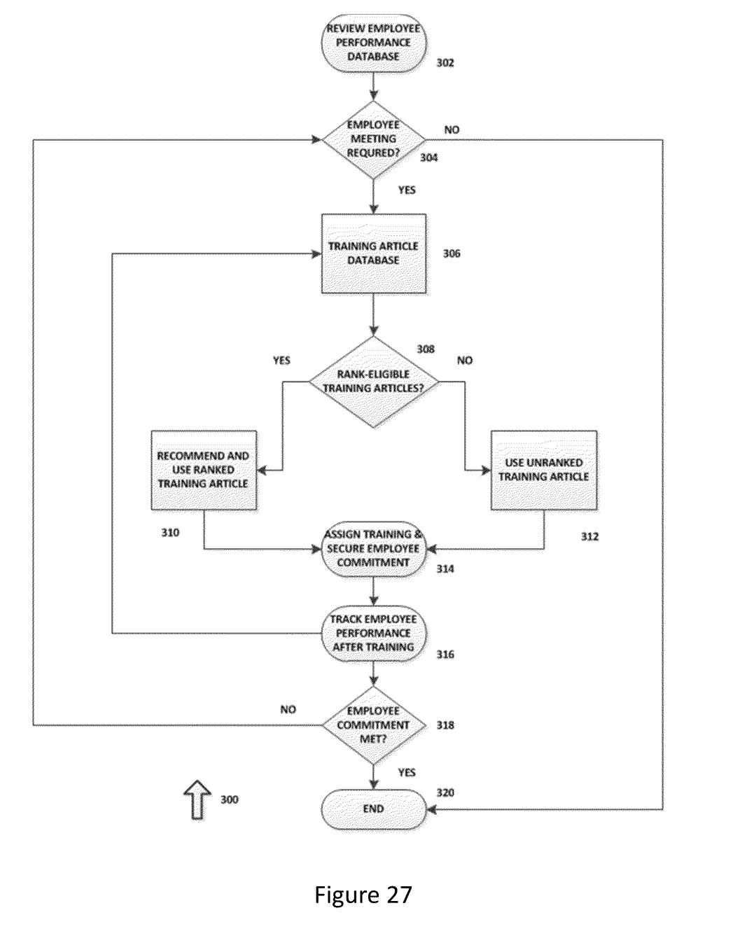

FIG. 27 is a diagram of an algorithm for improving employee performance in accordance with an exemplary embodiment of the present disclosure. Algorithm 300 can be implemented in hardware or a suitable combination of hardware and software, and can be one or more software systems operating on one or more processors.

Algorithm 300 begins 302 where users review an employee performance database. In one exemplary embodiment the employee performance database can include one or more objects, each having associated text and functional attributes or other suitable controls, and can be displayed and controlled by user based on a number of rankings, filters, and performance metrics, such as one or more predetermined data fields. The algorithm then proceeds to 304.

At 304, it is determined whether an employee's performance is satisfactory or fails to meet user expectations. If it is determined that the employee's performance is satisfactory, no employee meeting is required and the algorithm proceeds to 320. If it is determined that the employee's performance fails to meet expectations, the algorithm proceeds to 306.

At 306, users can access and review one or more training articles (i.e. employee performance improving techniques) stored in a training article database. Once the training article database has been accessed, the algorithm proceeds to 308.

At 308, it is determined whether specific training articles within the training article database are eligible for ranking based on prior performance in improving the performance of individual employees. If there are rank-eligible training articles, the algorithm proceeds to 310. If no training articles are eligible for ranking, the algorithm proceeds to 312.

At 310, it is determined which rank-eligible training articles are recommended for improving a particular employees performance based on the employee's past training experiences, past performance, and performance of the training articles with respect to other employees. The algorithm then proceeds to 314.

At 312, it is determined which unranked training article should be assigned to a particular employee based on the employee's preference and past training experiences. The algorithm then proceeds to 314.

At 314, the selected training article is assigned to the employee and an employee commitment is secured regarding future performance expectations. The algorithm then proceeds to 316.

At 316, the employee's performance is monitored and tracked to determine whether the particular training article assigned to the employee was successful in improving the employee's performance. The information collected is returned to the training article database at 306 to continuously monitor and rank training articles. The algorithm then proceeds to 318.

At 318, it is determined whether the employee has met the employee commitment and therefore whether the employee's performance is to be deemed satisfactory. If the employee has met their commitment and that employee's performance is deemed satisfactory, the algorithm is terminated at 320. Otherwise, the algorithm proceeds back to 304 and the process is repeated.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

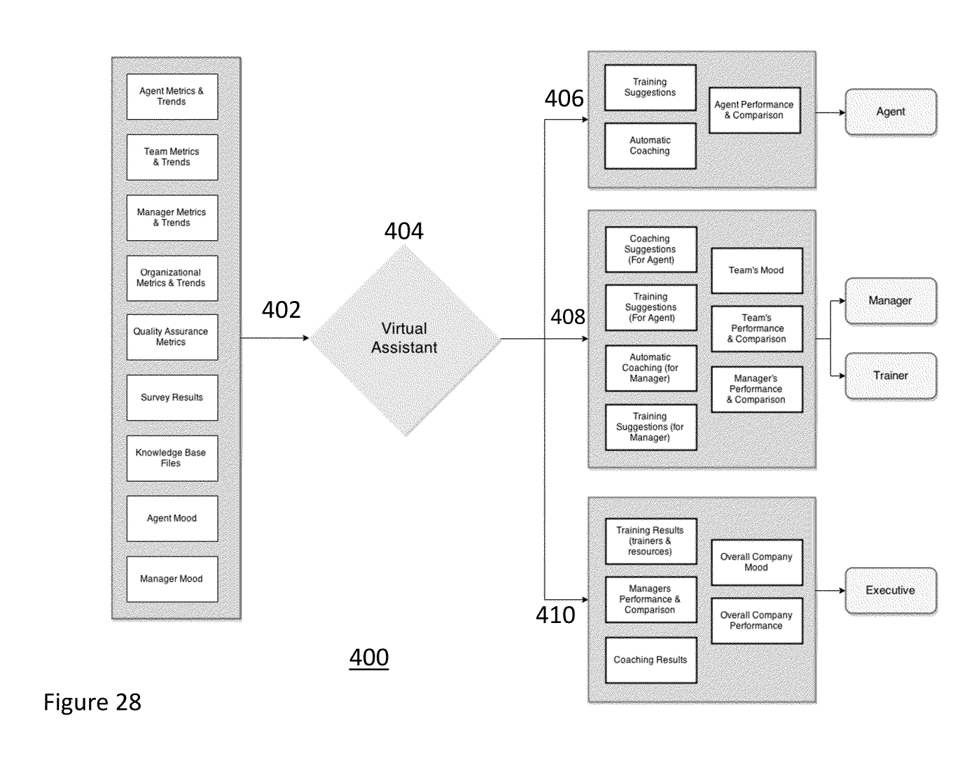

FIG. 28 is a diagram of an algorithm for the Intelligent Virtual Assistant in accordance with an exemplary embodiment of the present disclosure. Algorithm 400 can be implemented in hardware or a suitable combination of hardware and software, and can be one or more software systems operating on one or more processors.

Algorithm 400 begins 402 where the virtual assistant reviews data received from an employee performance and metrics database. In one exemplary embodiment the employee performance and metrics database can include one or more objects, each having associated text and functional attributes or other suitable controls, and can be displayed and controlled by the virtual assistant based on a number of rankings, filters, and performance metrics, such as one or more predetermined data fields. The algorithm then proceeds to 404.

At 404, it is determined which type of employee has been selected by the virtual assistant. If the virtual assistant has selected an individual employee, the algorithm proceeds to 406. If the virtual assistant has selected a manager or trainer, the algorithm proceeds to 408. If the virtual assistant has selected an executive, the algorithm proceeds to 410.

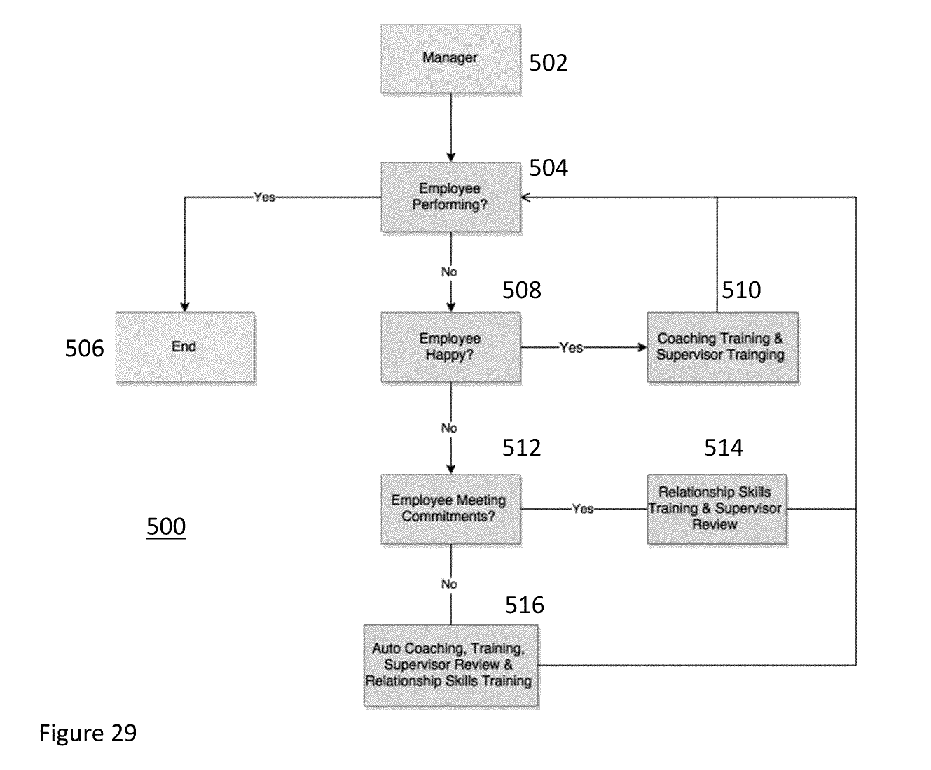

FIG. 29 is a diagram of an algorithm for improving the performance of a manager in his/her ability to improve performance and improve employee satisfaction in accordance with an exemplary embodiment of the present disclosure. Algorithm 500 can be implemented in hardware or a suitable combination of hardware and software, and can be one or more software systems operating on one or more processors.

Algorithm 500 begins 502 where a user reviews an employee performance and metrics database. In one exemplary embodiment the employee performance and metrics database can include one or more objects, each having associated text and functional attributes or other suitable controls, and can be displayed and controlled by the virtual assistant based on a number of rankings, filters, and performance metrics, such as one or more predetermined data fields. The algorithm then proceeds to 504.

At 504, it is determined whether an employee's performance is satisfactory or fails to meet user expectations. If it is determined that the employee's performance is satisfactory, no manager meeting is required and the algorithm proceeds to 506. If it is determined that the employee's performance fails to meet expectations, the algorithm proceeds to 508.

At 508, it is determined whether an employee's job satisfaction is satisfactory or fails to meet user expectations. If it is determined that the employee's job satisfaction is satisfactory, the algorithm proceeds to 510. If it is determined that the employee's job satisfaction fails to meet expectations, the algorithm proceeds to 512.

At 510, the manager receives Coaching Training and Supervisor Training to improve the performance of the employees the manager is responsible for. After receiving training, the algorithm returns to 504 and repeats the process.

At 512, it is determined whether the manager's employee has met the employee commitment and therefore whether the employee's performance is to be deemed satisfactory. If the employee has met their commitment and that employee's performance is deemed satisfactory, the algorithm is proceeds to 514. Otherwise, the algorithm proceeds to 516.

At 514, the manager receives Relationship Skills Training and Supervisor Review to improve the performance and job satisfaction of the employees the manager is responsible for. After receiving training, the algorithm returns to 504 and repeats the process.

At 516, the manager receives Auto Coaching, Training, Supervisor Review, and Relationship Skills Training to improve the performance, job satisfaction, and commitment levels of the employees the manager is responsible for. After receiving training, the algorithm returns to 504 and repeats the process.

What is claimed is:

1. A system for monitoring and improving employee performance, comprising:
an employee performance database system operating on a processor and configured to receive and store employee performance data;
an employee management system operating on a processor and configured to receive employee performance data from the employee performance database system and provide real-time performance metrics for employees; and
an employee training system operating on a processor and configured to receive real-time performance metrics for employees from the employee management system and provide recommended training articles to improve employee performance.

2. The system of claim 1 wherein the employee performance data and real-time performance metrics each comprise one or more of employee attendance, employee schedule adherence, employee hours worked, employee work quality, employee productivity, employee speed, employee compliance, employee safety, employee complaints, employee recommendations, and any other conventional data measurement for suitable purposes.

3. The system of claim 1 wherein the employee training system operating on a processor is configured to analyze real-time performance metrics for employees from the employee management system and determine whether any training articles are required to improve employee performance based on a number of criteria.

4. The system of claim 3 wherein the number of criteria comprise an employee's previous responsiveness to training articles in general, an employee's previous responsiveness to training articles for the purpose of improving a particular performance metric, the performance metric of the particular employee in comparison with performance metrics of similar employees, and the impact of particular training articles for the purpose of improving a performance metric of other employees.

5. The system of claim 1 wherein the employee performance database is configured to continuously receive and update stored employee performance data based on each successive action of the employee management system and employee training system.

6. The system of claim 1 further comprising an encapsulated artificial intelligence system configured to monitor employee performance data and determine whether any training articles are required to improve employee performance based on a performance algorithm.

7. The system of claim 1 further comprising an encapsulated artificial intelligence system configured to monitor employee performance data and determine which particular training articles are recommended to improve employee performance based on a performance algorithm.

8. A method for monitoring and improving employee performance, comprising:
receiving employee performance data from an employee performance database;
determining whether a particular employee is satisfying performance expectations;
determining whether a particular employee that is not meeting performance expectations requires training;
providing a recommended training method for a particular employee that is not meeting performance expectations;
assigning and administering a training method for the employee; and
tracking the employee performance after the training is administered.

9. The method of claim 8 wherein the method is performed using one or more processors.

10. The method of claim 8 wherein the employee performance data comprises one or more of employee attendance, employee schedule adherence, employee hours worked, employee work quality, employee productivity, employee speed, employee compliance, employee safety, employee complaints, employee recommendations, and any other conventional data measurement for suitable purposes.

11. The method of claim 8 wherein the step of determining whether a particular employee is satisfying performance expectations further comprises the process of comparing the particular employee's performance data with a performance algorithm.

12. The method of claim 8 wherein the step of determining whether a particular employee is satisfying performance expectations further comprises the process of comparing the particular employee's performance data with performance data of similarly situated employees.

13. The method of claim 8 wherein the step of determining whether a particular employee is satisfying performance expectations further comprises the process of comparing the particular employee's performance data with expected employee performance data measurements input by an operator.

14. The method of claim 8 wherein the step of determining whether a particular employee that is not meeting performance expectations requires training further comprises the process of comparing the particular employee's performance data with a performance algorithm.

15. The method of claim 8 wherein the step of determining whether a particular employee that is not meeting performance expectations requires training further comprises the process of comparing the particular employee's performance data with performance data of similarly situated employees who have received training.

16. The method of claim 8 wherein the step of providing a recommended training method for a particular employee that is not meeting performance expectations further comprises the process of comparing the particular employee's performance data with a performance algorithm.

17. The method of claim 8 wherein the step of providing a recommended training method for a particular employee that is not meeting performance expectations further comprises the process of comparing the particular employee's performance data with performance data of similarly situated employees who have received training.

18. The method of claim 8 wherein the step of assigning and administering a training method for an employee further comprises the process of notifying the employee and the employee's supervisor that a particular training method has been assigned and will be administered to the employee.

19. The method of claim 8 wherein the step of tracking the employee performance after the training is administered further comprises the process of comparing the particular employee's performance data prior to receiving training with the particular employee's performance data after receiving training.

20. In a system comprising an employee performance database system operating on a processor and configured to receive and store employee performance data, an employee management system operating on a processor and configured to receive employee performance data from the employee performance database system and provide real-time performance metrics for employees, and an employee training system operating on a processor and configured to receive real-time performance metrics for employees from the employee management system and provide recommended training articles to improve employee performance, a method comprising:
receiving employee performance data from an employee performance database;
determining whether a particular employee is satisfying performance expectations;
determining whether a particular employee that is not meeting performance expectations requires training;
providing a recommended training method for a particular employee that is not meeting performance expectations;
assigning and administering a training method for the employee; and
tracking the employee performance after the training is administered.
